(19) United States
(12) Patent Application Publication
(10) Pub. No.: US 2024/0123539 A1
(43) Pub. Date: Apr. 18, 2024

(54) RESISTANCE SPOT WELDED JOINT AND METHOD FOR MANUFACTURING RESISTANCE SPOT WELDED JOINT

(71) Applicant: NIPPON STEEL CORPORATION, Tokyo (JP)

(72) Inventors: Seiji FURUSAKO, Tokyo (JP); Satoshi HIROSE, Tokyo (JP); Chisato YOSHINAGA, Tokyo (JP)

(73) Assignee: NIPPON STEEL CORPORATION, Tokyo (JP)

(21) Appl. No.: 18/278,551

(22) PCT Filed: Apr. 5, 2021
(86) PCT No.: PCT/JP2021/014439

§ 371 Date: Aug. 23, 2023

(51) Int. Cl. B23K 11/11; F16B 5/08

(52) U.S. Cl. CPC B23K 11/115; F16B 5/08

(57) ABSTRACT

A resistance spot welded joint according to an aspect of the present invention includes: a plurality of overlapping steel sheets; and a weld having a nugget by which the steel sheets are joined, and having a corona bond and a heat-affected zone formed around the nugget, in which one or more of the plurality of steel sheets are high strength steel sheets having a tensile strength of 780 MPa or more, one or more of the plurality of steel sheets are plated steel sheets having a zinc-based plating, the high strength steel sheet and the zinc-based plating are adjacent to each other on a contact surface, a diameter of the heat-affected zone is 1.5 times or more a diameter of the nugget, in the heat-affected zone, carbides having a circle equivalent diameter of 0.1 or more are distributed at a number density of 40/100 μm² or more, and in the corona bond, an amount of an η phase of the zinc-based plating is 20 area % or less.

### TECHNICAL FIELD OF THE INVENTION

The present invention relates to a resistance spot welded joint and a method for manufacturing a resistance spot welded joint.

### RELATED ART

In recent years, in the field of vehicles, there is a demand for a reduction in a weight of a vehicle body in order to achieve lower fuel consumption and CO₂ emissions. Furthermore, in the field of vehicles, there is a demand for high-strengthening of a vehicle body member in order to improve collision safety. In order to satisfy these requirements, it is effective to use a high strength steel sheet as materials for various components such as the vehicle body member.

In addition, from the viewpoint of high antirust properties of a vehicle body, the member needs to be made of a steel sheet having excellent corrosion resistance. It is widely known that a zinc-based plated steel sheet has good corrosion resistance. From the viewpoint of the reduction in the weight and high-strengthening, a zinc-based plated steel sheet used for a vehicle is usually joined to a high strength steel sheet, or a high strength steel sheet is usually used as a base steel sheet to be plated.

Resistance spot welding is mainly used in steps such as assembly of a vehicle body of a vehicle and attachment of components. Resistance spot welding is a type of resistance welding in which overlapping base metals are clamped between tips of electrodes of which the tips are appropriately shaped, and a current and a force are concentrated into a relatively small portion to locally heat and simultaneously apply force on the portion with the electrodes. Various methods have been proposed for applying resistance spot welding to the joining of high strength steel sheets.

Patent Document 1 discloses a spot welding method of a high tensile strength steel sheet in which spot welding of a high tensile strength steel sheet is performed by steps including a first step of generating a nugget by gradually increasing an energizing current applied to the high tensile strength steel sheet, a second step of decreasing the current after the first step, and a third step of increasing the current after the second step to perform main welding and gradually decreasing the energizing current.

Patent Document 2 discloses a spot welding method of an aluminum-plated steel sheet including: overlapping aluminum-plated steel sheets or an aluminum-plated steel sheet and another metal sheet as a material to be welded, applying force on the steel sheets in a state of being clamped between a pair of electrode tips, melting a weld of the material to be welded by Joule heat by energizing the electrode tips, and thereafter stopping the energizing to allow the weld to cool and solidify and form a nugget, in which an upslope step of gradually increasing an energizing amount is added as a pre-step of a main welding step of energizing the weld in a constant AC cycle to moderate a temperature rising rate of the weld.

Patent Document 3 discloses a method for manufacturing a steel-aluminum joining structure in which a weld current is supplied to a material to be welded in an energizing pattern in which, when an aluminum material and a hot-dip aluminum-plated steel sheet are overlapped and integrated by spot welding, a ratio Q1/Q2 of an integrated current Q1 of an upslope period from the start of energizing to the until a weld current reaches a set value W to an integrated current Q2 of a constant current welding period is set to 0.05 to 3.0, and the sum Q1+Q2 is set to 1 to 5 kA kA·sec.

However, when resistance spot welding is performed on a high strength steel sheet having a zinc-based plating or a high strength steel sheet in contact with a zinc-based plated steel sheet, there is a problem that cracking due to liquid metal embrittlement (LME) occurs. LME cracking is intergranular cracking caused by the infiltration of zinc, which is melted and liquified, into grain boundaries of a steel sheet.

It is said that LME cracking is likely to occur when the following factors are met.

(A) A zinc-based plating is provided on a contact surface of steel sheets.

(B) The zinc-based plating on the contact surface is provided on a high strength steel sheet or is provided on the steel sheet overlapping the high strength steel sheet and is in contact with the high strength steel sheet (hereinafter, this state is referred to as “the high strength steel sheet and the zinc-based plating are adjacent to each other”).

(C) In a process in which the steel sheet and a nugget are cooled after the nugget is formed, a high tensile stress is applied to the periphery of the nugget.

In addition, as causes for applying a high tensile stress, for example, four types of disturbances described in paragraph 0021 of Patent Document 4 and shown in FIGS. 4 to 7 are known. When resistance spot welding is performed in a state where these factors are met, molten zinc infiltrates into grain boundaries of the high strength steel sheet, and cracking occurs at the grain boundaries. The tensile stress promotes the infiltration of liquid zinc into the grain boundaries.

In a vehicle body, there is a problem in that a strength of a member decreases when a welded portion is significantly cracked. Therefore, the occurrence of LME cracking needs to be suppressed as much as possible. However, suppressing LME cracking by controlling components of the steel sheet or the zinc-based plating is not preferable because the degree of freedom in material selection of the vehicle body is reduced. Therefore, there is a demand for a resistance spot welding method capable of suppressing LME cracking.

### PRIOR ART DOCUMENT

### [Patent Document]

[Patent Document 1] Japanese Unexamined Patent Application, First Publication No. 2003-236674
[Patent Document 2] Japanese Unexamined Patent Application, First Publication No. 2006-212649
[Patent Document 3] Japanese Unexamined Patent Application, First Publication No. 2006-224127
[Patent Document 4] Japanese Patent No. 6108017

### DISCLOSURE OF THE INVENTION

### Problems to be Solved by the Invention

As one of measures for preventing LME cracking, there is a technique for lengthening a force hold time. Force holding for a long period of time means that a force applied to the steel sheets during the formation of the nugget is held for a predetermined time even after the end of energizing. According to this, it is possible to prevent an LME crack C (see FIG. 1A) in the vicinity of an outer edge of a corona bond formed around the nugget. The crack in the corona bond is likely to occur in a case where the nugget is relatively small, or in a case where the degree of disturbance such as a hitting angle, a clearance, and a gap between sheets is large and a radius of the corona bond is small.

However, it was found that it is difficult to completely prevent LME cracking even by the above-described resistance spot welding in which force holding is performed for a long period of time. As a result of repeated investigations on the form of LME cracking by the present inventors, it was found that force holding does not have an effect of suppressing the LME crack C (see FIG. 1B) in the corona bond around the nugget.

All of the resistance spot welding methods described in the patent documents are characterized in that an energizing pattern is optimized. However, in any of these documents, LME cracking is not considered. In addition, it was confirmed by the present inventors that in a case where the resistance spot welding method described in the above-described patent document is applied to a sheet assembly in which a zinc-based plating and a high strength steel sheet are combined, LME cracking in a corona bond around a nugget cannot be suppressed.

In view of the above circumstances, an object of the present invention is to provide a resistance spot welded joint and a method for manufacturing a resistance spot welded joint in which LME cracking does not occur in a corona bond even though a zinc-based plating and a high strength steel sheet are adjacent to each other on a contact surface.

### Means for Solving the Problem

The gist of the present invention is as follows.

(1) A resistance spot welded joint according to an aspect of the present invention includes: a plurality of overlapping steel sheets; and a weld having a nugget by which the steel sheets are joined, and having a corona bond and a heat-affected zone formed around the nugget, in which one or more of the plurality of steel sheets are high strength steel sheets having a tensile strength of 780 MPa or more, one or more of the plurality of steel sheets are plated steel sheets having a zinc-based plating, the high strength steel sheet and the zinc-based plating are adjacent to each other on a contact surface, a diameter of the heat-affected zone is 1.5 times or more a diameter of the nugget, in the heat-affected zone, carbides having a circle equivalent diameter of 0.1 μm or more are distributed at a number density of 40/100 μm² or more, and in the corona bond, an amount of an η phase of the zinc-based plating is 20 area % or less.

(2) In the resistance spot welded joint according to (1), one or more of the following three requirements may be satisfied:
1: a raised portion of a shoulder portion of the weld protrudes outward by 0.1 mm or more from a surface of the steel sheet on which the raised portion is formed;
2: an angle between a major axis direction of the nugget and the surface of the steel sheet around the weld is 2° or more; and
3: a sheet separation in the contact surface at which the high strength steel sheet and the zinc-based plating are adjacent to each other is 0.3 mm or more.

(3) A method for manufacturing a resistance spot welded joint according to another aspect of the present invention, includes: applying a force on a plurality of overlapping steel sheets using a pair of electrodes facing each other; forming a nugget and a corona bond by energizing the electrodes while applying the force on the steel sheets; and decreasing a current value between the electrodes to zero while holding a force on the steel sheets, in which one or more of the plurality of steel sheets include a zinc-based plating, and one or more of the plurality of steel sheets are high strength steel sheets having a tensile strength of 780 MPa or more, the high strength steel sheet and the zinc-based plating are brought adjacent to each other on a contact surface, a current value I between the electrodes at a time when the formation of the nugget is completed, and an average value Iave of the current value between the electrodes in a first period, which is a period from the time when the formation of the nugget is completed to a time when the current value is set to zero, satisfy a relationship of 0.30×I≤Iave≤0.90×I, a length of a second period, which is a period from a time when the current value is set to 0.90×I to a time when the current value is set to 0.30×I, is set to 420 msec or more, and a force in the first period is set to be 1.1 times or more a force P at the time when the formation of the nugget is completed.

(4) In the method for manufacturing a resistance spot welded joint according to (3), in a case where ½ of a total sheet thickness of the steel sheet in a unit of mm is defined as tm, while the current value between the electrodes is decreased to zero, the current value between the electrodes may be held at a constant value in a range of I×0.9 to I×0.3 for a time between 265×tm or longer and 420 msec or longer in a unit of msec.

(5) The method for manufacturing a resistance spot welded joint according to (3) or (4) may further include: after the decreasing of the current value between the electrodes to zero, holding the force at 0.8×P or higher for a time between 0.04 sec or longer and 0.4 sec or shorter in a state where the current value between the electrodes is set to zero.

(6) In the method for manufacturing a resistance spot welded joint according to any one of (3) to (5), Iave and I may satisfy a relationship of 0.45×I≤Iave≤0.85×I.

(7) In the method for manufacturing a resistance spot welded joint according to any one of (3) to (6), in a case where ½ of a total sheet thickness of the steel sheet in a unit of mm may be defined as tm, the length of the second period may be set to 265×tm or more and 420 msec or more in a unit of msec.

### Effects of the Invention

According to the present invention, it is possible to provide a resistance spot welded joint and a method for manufacturing a resistance spot welded joint in which LME cracking does not occur in a corona bond even though a zinc-based plating and a high strength steel sheet are adjacent to each other on a contact surface.

### BRIEF DESCRIPTION OF THE DRAWINGS

FIG. 1A is a schematic view of an LME crack that occurs in the vicinity of an outer edge of a corona bond.

FIG. 1B is a schematic view of an LME crack that occurs inside the corona bond.

FIG. 2A is a schematic view showing step S1 in a method for manufacturing a resistance spot welded joint according to an aspect of the present invention.

FIG. 2B is a schematic view showing steps S2 to S4 in the method for manufacturing a resistance spot welded joint according to the aspect of the present invention.

FIG. 3 is a graph schematically showing changes over time in current and force in the method for manufacturing a resistance spot welded joint according to the aspect of the present invention.

FIG. 4 is a graph schematically showing changes over time in current and force in the method for manufacturing a resistance spot welded joint according to the aspect of the present invention.

FIG. 5A is a graph of simulation results in which an influence of the time required for decreasing a current value on a tensile stress in the corona bond is verified.

FIG. 5B is a graph of simulation results in which an influence of the time required for decreasing a current value on a tensile stress in the corona bond is verified.

FIG. 5C is a graph in which the graphs of FIGS. 5A and 5B are superimposed.

FIG. 6A is a cross-sectional photograph of resistance spot welded joints manufactured under various conditions.

FIG. 6B is a cross-sectional photograph of resistance spot welded joints manufactured under various conditions.

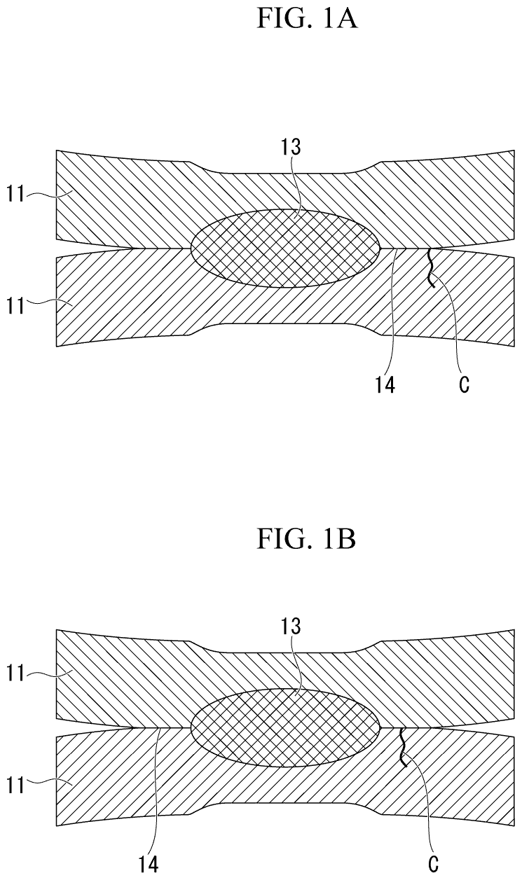

### EMBODIMENTS OF THE INVENTION

The present inventors repeatedly studied measures for suppressing LME cracking, particularly LME cracking in a corona bond around a nugget. The nugget means a melted and solidified portion formed in a weld in lap resistance welding (JIS Z 3001-6:2013). In addition, for convenience, a molten metal before melting and solidification is also referred to as a nugget. The corona bond means a solid-phase welded ring-shaped portion formed around the nugget in lap resistance welding (JIS Z 3001-6:2013). In addition, in the present embodiment, the term “weld” means a region having the nugget, the corona bond, and a heat-affected zone.

The present inventors found that in resistance spot welding, by forming a nugget by applying force on steel sheets and energizing the steel sheets, and then gradually decreasing a current value in a state where a force is increased, LME cracking in a corona bond around the nugget can be suppressed. Specifically, after formation of a nugget, LME cracking could be suppressed by follows:
(1) a current value I when the formation of the nugget is completed and an average value Iave of a current value in a first period satisfy a relationship of 0.30×I Iave≤0.90×I,
(2) a length of a second period is set to 420 msec or more, and
(3) a force in the first period is always set to 1.1 times or more a force P at a time when the formation of the nugget is completed,

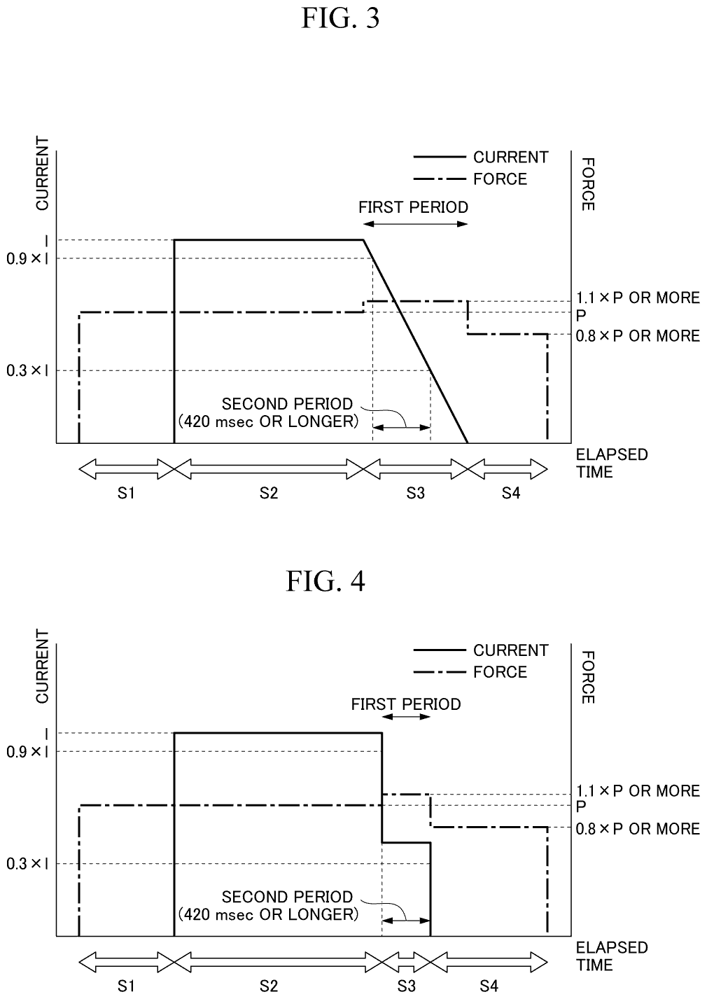

Here, as shown in FIG. 3, the “first period” is a period from the time when the formation of the nugget is completed to a time when the current value is set to zero. In addition, as shown in FIG. 3, the “second period” is, in decreasing a current value between electrodes to zero while holding force on steel sheets, a period from a time when the current value is set to 0.90×I to a time when the current value is 0.30×I. In FIG. 3, the current value continues to gradually decrease after the formation of the nugget. However, as long as the above requirements are satisfied, there may be a period during which the current value is constant after the formation of the nugget. For example, the current value may be constant in a part or all of the second period. For example, an energizing pattern after the formation of the nugget may be a stepwise pattern as shown in FIG. 4, which will be described later (two-step current drop pattern). In this case, the current value is constant in the entire second period, and the first period and the second period coincide with each other. In addition, the energizing pattern after the formation of the nugget may include current value holding at any current value Ia lower than the current value I and current value holding at any current value Ib lower than the current value Ia (three-step current drop pattern).

LME cracking is caused by the infiltration of liquid zinc into grain boundaries. The second period is a period in which zinc is liquefied and a risk of occurrence of LME cracking is high. Intuitively, it is considered that the occurrence of LME cracking can be suppressed by shortening this period as much as possible. However, in practice, rapid cooling of the nugget after the formation of the nugget rather promotes the generation of LME cracks in a corona bond. Therefore, the present inventors concluded that the nugget has to be slowly cooled and the second period has to be 420 msec or longer.

The reason why such welding conditions suppress LME cracking in the corona bond is not clear at present, but the present inventors presumed that the suppression is achieved by the following mechanism.

The present inventors presumed that changes in stress and temperature in the corona bond around the nugget over time affect LME cracking at this portion. However, it is difficult to actually measure changes in the temperature and the magnitude of the tensile stress in the corona bond over time. Therefore, the present inventors carried out various simulations regarding changes in temperature and stress over time in the vicinity of the corona bond during resistance spot welding. As a result, it was found that in resistance spot welding satisfying the above-described conditions (1) to (3), there is a high probability that a tensile stress generated in a region having a temperature in a range of 907° C. to 420° C. in a corona bond within a range of 1 mm from a nugget in a first period is extremely reduced compared to that in the related art. Hereinafter, “a region in a range of 907° C. to 420° C. in a corona bond within a range of 1 mm from a nugget” is referred to as a high crack risk region. This is because, in the high crack risk region, a high strength steel sheet and liquid zinc are in contact with each other, so that there is an extremely high concern that molten zinc infiltrates into grain boundaries of the high strength steel sheet.

A shape of the high crack risk region changes over time. A temperature of the corona bond is not uniform, and increases toward a portion where the nugget is formed. Therefore, as the solidification of the molten metal progresses, zinc is liquefied at a portion adjacent to the nugget (corona bond or in the immediate vicinity outside thereof), and the high crack risk region is formed. It is considered that zinc at the portion where the nugget is formed melts and evaporates in an initial stage of heating before the steel sheet melts at the portion, and substantially all of the zinc dissipates to an outside of the portion. Therefore, it is presumed that zinc at the portion where the nugget is formed does not pose a problem.

Next, as a temperature of a weld decreases, zinc in the portion adjacent to the nugget (including, in the corona bond and in the immediate vicinity outside thereof, the entire range within 1 mm from the nugget, which is particularly targeted for improvement in a resistance spot welding method according to the present embodiment) solidifies, and the high crack risk region disappears.

As a result of the simulations by the present inventors, it was presumed that in a case where a length of a second period is set to 420 msec or more while increasing a force to a value of 1.1×P or higher holding the force after the formation of the nugget, a tensile stress generated in the high crack risk region is suppressed to approximately 200 MPa or less. Here, the symbol P means the force at the time when the formation of the nugget is completed, as described above. The tensile stress promotes the infiltration of liquid zinc into the grain boundaries. Therefore, it is presumed that the relaxation of the tensile stress in the high crack risk region greatly contributes to the suppression of the occurrence of LME cracking. This is well consistent with the fact that the occurrence of LME cracking is suppressed.

### First Embodiment

A method for manufacturing a resistance spot welded joint (resistance spot welding method) according to an aspect of the present invention obtained by the above findings includes:
(S1) applying force on two or more overlapping steel sheets 11 using a pair of electrodes A facing each other;
(S2) forming a nugget 13 and a corona bond 14 by energizing the electrodes A while applying the force on the steel sheets 11; and
(S3) decreasing a current value between the electrodes A to zero while holding the force on the steel sheets 11,
in which one or more of the steel sheets 11 is a high strength steel sheet 11′ having a tensile strength of 780 MPa or more, a zinc-based plating 12 is disposed on a surface of the one or more steel sheets 11, the high strength steel sheet 11′ and the zinc-based plating 12 are brought adjacent to each other on a contact surface 15, a current value I between the electrodes at a time when the formation of the nugget 13 is completed, and an average value Iave of the current value between the electrodes in a first period, which is a period from the time when the formation of the nugget 13 is completed to a time when the current value is set to zero, satisfy a relationship of 0.30×I≤Iave≤0.90×I, a length of a second period, which is a period from a time when the current value is set to 0.90×I to a time when the current value is set to 0.30×I, is set to 420 msec or more, and a force in the first period is always set to be 1.1 times or more a force P at the time when the formation of the nugget is completed. Hereinafter, the method for manufacturing a resistance spot welded joint according to the present embodiment will be described in detail.

(Step S1)

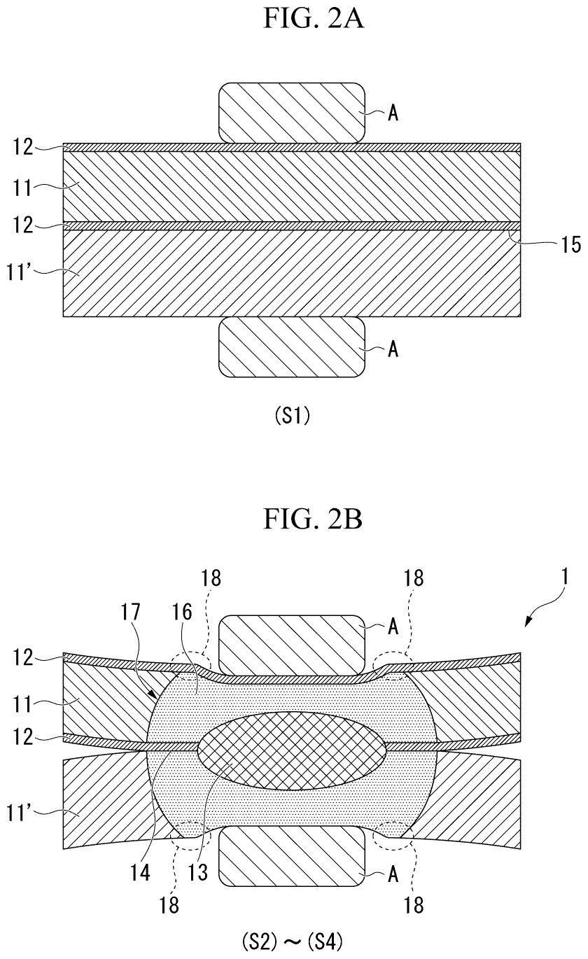

In step S1, force is applied on two or more overlapping steel sheets 11 using the pair of electrodes A facing each other. Here, one or more of the steel sheets 11 are steel sheets having a tensile strength of 780 MPa or more. Hereinafter, a steel sheet having a tensile strength of 780 MPa or more will be referred to as the high strength steel sheet 11′. In addition, one or more of the steel sheets 11 are zinc-based plated steel sheets. Here, the zinc-based plating 12 may be disposed on a surface of the high strength steel sheet 11′ or may be disposed on a surface of a steel sheet having a tensile strength of less than 780 MPa. The zinc-based plating 12 may be disposed on one surface of the steel sheet 11 or may be disposed on both surfaces thereof. In a resistance spot welding method illustrated in FIGS. 2A and 2B, the high strength steel sheet 11′ does not have the zinc-based plating 12, and the steel sheet 11 (low strength steel sheet) having a tensile strength of less than 780 MPa is provided with the zinc-based plating 12 on both surfaces thereof.

Then, when the steel sheets 11 are overlapped with each other, the high strength steel sheet 11′ and the zinc-based plating 12 are brought adjacent to each other on the contact surface 15 of the steel sheets. Here, a state in which the high strength steel sheet 11′ and the zinc-based plating 12 are adjacent to each other means both a state in which the zinc-based plating 12 is disposed on the surface of the high strength steel sheet 11′ and a state in which the zinc-based plating 12 is disposed on the steel sheet overlapping with the high strength steel sheet 11′ and the zinc-based plating 12 is in contact with the high strength steel sheet 11′. In the resistance spot welding method illustrated in FIGS. 2A and 2B, the zinc-based plating 12 is disposed on the steel sheet overlapping with the high strength steel sheet 11′, whereby the high strength steel sheet 11′ and the zinc-based plating 12 are brought adjacent to each other on the contact surface 15 of the steel sheet.

In a case where the steel sheets 11 are overlapped with each other so that the high strength steel sheet 11′ and the zinc-based plating 12 are brought adjacent to each other on the contact surface 15 of the steel sheet 11 and resistance spot welding is performed, liquid zinc comes into contact with the high strength steel sheet 11′. This is one of the factors that cause LME cracking. Since an object of the resistance spot welded joint according to the present embodiment is to suppress LME cracking, the high strength steel sheet 11′ and the zinc-based plating 12 are brought adjacent to each other on the contact surface 15 of the steel sheet 11. Accordingly, the degree of freedom in the design of mechanical components manufactured by resistance spot welding can be increased.

Then, force is applied on the two or more steel sheets 11 that are overlapped with each other using the pair of electrodes A facing each other. A shape, a structure, and the like of the electrode A are not particularly limited, and those used for ordinary resistance spot welding may be appropriately used. The force is also not particularly limited, and a value depending on a sheet thickness, the number of sheets, and a material of the steel sheets 11 to be joined may be appropriately set within a normal range. Various force conditions preferable for forming the nugget 13 can be applied to step S1. In addition, a composition, a metallographic structure, mechanical properties other than the tensile strength, and a shape of the steel sheet 11 are not particularly limited and can be appropriately selected depending on an application of the resistance spot welded joint. A type of the zinc-based plating 12 is not particularly limited, and forms such as hot-dip galvanizing, hot-dip galvannealing, and electrogalvanizing can be appropriately selected. An adhesion amount of the zinc-based plating 12 is also not particularly limited.

(Step S2)

Next, in step S2, the nugget 13 and the corona bond 14 are formed by energizing the electrodes A while applying the force on the steel sheet 11.

An energizing time and a current value are not particularly limited, and values according to the sheet thickness, the number of sheets, and the material of the steel sheet 11 to be joined may be appropriately set within normal ranges. In FIG. 3, the current value in step S2 is set to a maximum value immediately after the start of energizing. However, in step S2, the current value may be gradually increased to reach the maximum value (so-called upslope energizing). In addition, energizing at a low current for preheating the steel sheet 11 (preliminary energizing) may be performed before energizing at a high current for forming the nugget 13 (main energizing). Various energizing conditions preferable for forming the nugget 13 can be applied to step S2.

In addition, the force is also not particularly limited, and a value depending on the sheet thickness, the number of sheets, and the material of the steel sheets 11 to be joined may be appropriately set within a normal range. In FIG. 3, the force in step S2 is constant, but may also be appropriately changed within a range in which a favorable nugget 13 can be formed. Various conditions preferable for forming the nugget 13 can be applied to step S2. In addition, although it is assumed that the force unintentionally fluctuates due to accuracy of a resistance spot welding apparatus, such fluctuation in the force is allowed within a range in which a favorable nugget 13 can be formed.

(Step S3)

Next, in step S3, the current value between the electrodes A is decreased to zero. This step S3 is extremely important for suppressing LME cracking that occurs inside the corona bond. In normal resistance spot welding, after the nugget 13 is formed by the energizing, the current value between the electrodes A is immediately decreased to zero. In order to perform a heat treatment such as tempering on the nugget 13, there are cases where the nugget 13 is subjected to post energizing after the nugget 13 is formed. Even in this case, the current value is once decreased to zero or near zero to allow some or all of the molten metal to solidify, and then re-energizing is performed. On the other hand, in the resistance spot welding according to the present embodiment, as shown in FIG. 3, while the current value between the electrodes A is decreased to zero, the following three conditions are satisfied.

(1) The current value I when the formation of the nugget 13 is completed and the average value Iave of the current value in the first period satisfy the relationship of 0.30×I≤Iave≤0.90×I.

(2) The length of the second period is set to 420 msec or more.

(3) The force in the first period is always set to 1.1 times or more the force P at the time when the formation of the nugget 13 is completed.

Here, the “first period” is the period from the time when the formation of the nugget is completed to the time when the current value is set to zero. The “second period” is, in decreasing the current value between the electrodes to zero while holding the force on the steel sheets, the period from the time when the current value is set to 0.90×I to the time when the current value is set to 0.30×I. “The time when the formation of the nugget 13 is completed” refers to a time when a size of a molten portion of the steel sheet 11 reaches a size of the nugget 13 to be obtained in step S2. In addition, step S2, that is, a time when the main energizing is completed, may be regarded as “the time when the formation of the nugget 13 is completed”.

According to experimental results by the present inventors, LME cracking in the corona bond 14 could be effectively suppressed by gradually decreasing the current value while maintaining the state in which the force was increased. The reason for this is presumed to be as follows.

LME cracking is considered to occur when the high strength steel sheet 11′ is in contact with liquid zinc and a tensile stress is applied to the high strength steel sheet 11′. It is known that in resistance spot welding, stress is introduced into the corona bond 14 mainly when the force applied by the electrodes A is released. In addition, in the corona bond 14, the high strength steel sheet 11′ and the liquid zinc can come into contact with each other when a temperature of the corona bond 14 is 907° C. (a temperature at which zinc vapor can liquefy) or lower and 420° C. (a temperature at which liquid zinc can solidify) or higher. Therefore, by holding the force applied by the electrodes A at a value of 1.1×P or higher until the temperature of the corona bond 14 falls below about 420° C., the tensile stress generated in the corona bond 14 while the high strength steel sheet 11′ and the liquid zinc are in contact with each other can be relaxed to some extent.

In a case where the zinc-based plating 12 is a hot-dip galvanneal, an iron concentration in a plating layer may be, for example, about 10%. A melting point of the hot-dip galvanneal is about 600° C. Therefore, a lower limit temperature at which LME cracking occurs in the corona bond 14 depends on components of the zinc-based plating formed on the steel sheet 11. A melting point of pure zinc is 420° C., and in the case of using a hot-dip galvanized steel sheet in which a plating layer is not alloyed, 420° C. is set as a lower limit temperature at which LME occurs. However, even in the case of a hot-dip galvanized steel sheet, alloying progresses to some extent during heating for welding, so that an actual melting point of the plating layer is considered to exceed 420° C. Therefore, depending on the types of the steel sheet and the zinc-based plating, welding conditions, and the like, the lower limit temperature at which LME occurs may be 450° C., 500° C., 550° C., or the like.

On the other hand, although a boiling point of pure zinc is 907° C., the boiling point increases when iron and zinc are mixed. However, a yield strength and a tensile strength of the steel sheet decrease as the temperature increases. Therefore, it is considered that the tensile stress generated in the weld at 800° C. or higher is substantially lower than 200 MPa. Therefore, in a category of a high strength steel sheet industrially used, an upper limit temperature at which LME occurs may be 850° C., 800° C., or the like.

However, as a result of detailed simulations of a stress distribution and a heat distribution during spot welding by the present inventors, it was found that even if the force applied by the electrodes A is maintained at 1.1×P or higher, a tensile stress is introduced into the corona bond 14 in a process of decreasing the current value between the electrodes. It is considered that this is because a cooling medium always flows inside the electrodes A, and when the force applied by the electrodes A is holded at 1.1×P or higher after the end of energizing, the weld is rapidly cooled and contracted. Since the weld is restrained by the steel sheets 11 around the weld, when the weld contracts, the weld receives a tensile stress by the steel sheet 11 around the weld.

On the other hand, it was found that in a case where the length of the second period, which is a period during which the current value between the electrodes A is decreased from I×0.9 to I×0.3, is set to 420 msec or more, and the relationship of 0.30×I≤Iave≤0.90×I is satisfied, the tensile stress introduced into the corona bond 14 decreases in the process of decreasing the current value between the electrodes.

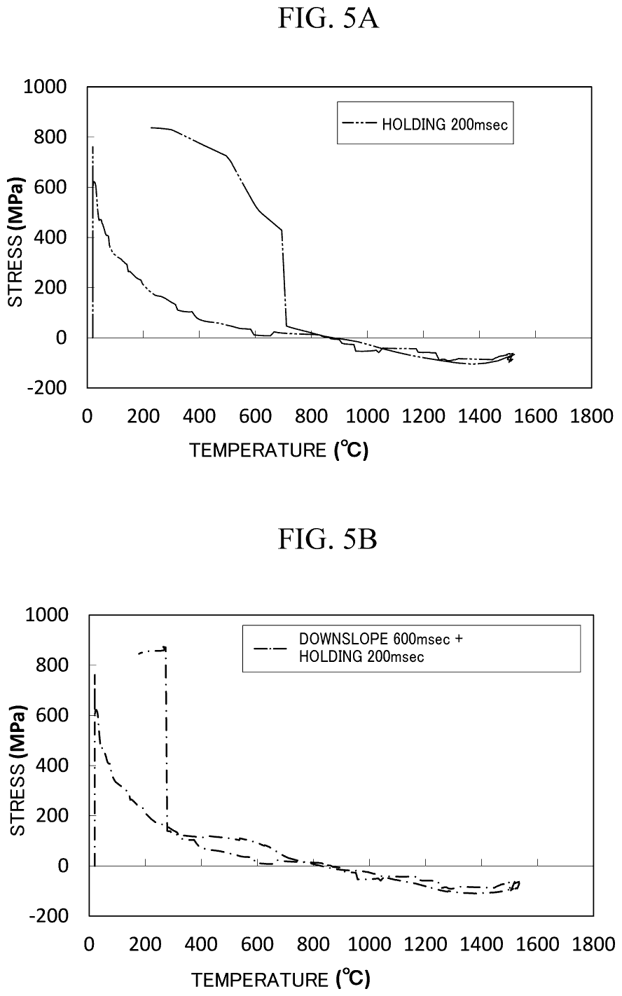

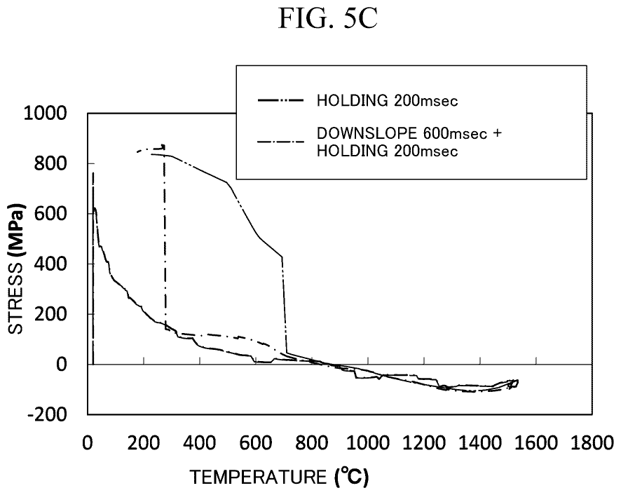

In a case where the length of the second period and the average value Iave of the current value in the first period are within the above ranges, the current value gradually decreases after the formation of the nugget 13. Here, FIGS. 5A to 5C show simulation results for estimating transitions of the tensile stress of the corona bond 14 between a case where the current value is rapidly decreased and a case where the current value is gradually decreased. As analysis conditions, two 980 MPa-grade zinc-based plated steel sheets having a sheet thickness of 1.6 mm were used, and a gap of 2 mm and a clearance of 0.5 mm between the sheets were given as disturbance conditions. At the time when the formation of the nugget was completed, the force P was set to 3.9 kN, and in the first period, the force was set to 4.5 kN, the current was set to 6 kA, and the energizing time was set to 320 msec.

The graph of FIG. 5A is a simulation result showing changes over time in the temperature and stress of the corona bond under a condition in which the force is held at 1.1×P or higher for 10 cycles (=0.2 sec) after the end of energizing. In the graph, the vertical axis represents the stress of the corona bond, and the horizontal axis represents the temperature of the corona bond. The positive side represents the tensile stress and the negative side represents a compressive stress. In FIG. 5A, the simulation result shows that, at first, the force is applied on the steel sheets by the electrodes at room temperature so that the tensile stress in the corona bond increases, the tensile stress then decreases as the temperature rises, and the tensile stress then increases again as the temperature decreases. It is expected that at a time when the temperature drops to about 700° C., the electrodes are released and the tensile stress significantly increases.

The graph of FIG. 5B is a stress simulation result in a case where the current value between the electrodes A is set to a downslope of 30 cycles (that is, the time required for the current value to decrease from I to zero is 30 cycles (=600 msec)), and a time for which the force is held at 1.1×P or higher is 10 cycles (=200 msec). At this time, the length of the second period was set to 360 msec. The changes in the stress and the temperature of the corona bond in FIG. 5B are expected to be similar to those in FIG. 5A up to a halfway point. However, also in FIG. 5B, it is expected that an increase in the tensile stress is suppressed compared to FIG. 5A at the time when the temperature drops to about 700° C.

FIG. 5C shows FIGS. 5A and 5B superimposed for reference. According to FIG. 5C, it is clearly shown in the simulation that the increase in the tensile stress during cooling is further suppressed by adding the downslope of the current value. As described above, the simulation results show that in the case where the current value is gradually decreased, the tensile stress is significantly reduced compared to the case where the current value is rapidly decreased.

In a case where the current value I at the time when the formation of the nugget is completed and the average value Iave of the current value in the first period satisfy the relationship of 0.30×I≤Iave≤0.90×I, and the length of the second period is set to 420 msec or more, a cooling rate of the weld decreases. Furthermore, in this case, heat removal by the electrodes A is reduced, and heat transfer from the weld to the steel sheets 11 around the weld is promoted. As a result, when the temperature of the weld decreases, the weld contracts more slowly, and a restraining force on the weld by the steel sheets 11 around the weld decreases. The present inventors presume that the tensile stress in the weld is further reduced by such a mechanism. Iave and I may satisfy a relationship of 0.45×I≤Iave≤0.85×I.

In addition, the present inventors determine, as a period during which the current value between the electrodes A has to be controlled, a period from when the current value between the electrodes A reaches 1×0.9 to when the current value between the electrodes A drops to I×0.3. This is because it is presumed that the temperature of the corona bond 14 when the current value between the electrodes A is I×0.9 roughly coincides with the boiling point of zinc, and the temperature of the corona bond 14 when the current value between the electrodes A is I×0.3 roughly coincides with the melting point of zinc. Based on this presumption, the second period is a period in which molten zinc that causes LME cracking is present around the nugget 13. In practice, by controlling the length of the second period determined as described above, an effect of suppressing LME cracking in the corona bond was confirmed.

In addition, according to experimental results by the present inventors, the longer the second period, the lower the frequency of occurrence of LME cracking in the corona bond 14. Therefore, the length of the second period may be specified as 450 msec, 480 msec or more, 500 msec or more, 600 msec or more, or 800 msec or more.

In addition, it is preferable that the second period is lengthened as the sheet thickness of the steel sheet increases. Therefore, the length of the second period may be determined according to the sheet thickness of the steel sheet. For example, in a case where a value of ½ of a total sheet thickness of the steel sheets in the unit of mm is defined as “tm”, the length of the second period may be determined to be 265×tm or more and 420 msec or more in the unit of msec. In other words, a lower limit of the length of the second period may be the longer of 265×tm (msec), which is a lower limit corresponding to the sheet thickness, and 420 msec, which is the above-described lower limit.

The force in the first period is always set to 1.1×P or higher. This is because, in a case where a period in which the force is less than 1.1×P is included in the first period, it is expected that a tensile stress is introduced into the weld and LME cracking is promoted. As illustrated in FIGS. 3 and 4, the force in the first period may be increased to a value of 1.1×P or higher at the same time as the end of step S2 in which the nugget is formed and then held at a constant value. On the other hand, the force may be allowed to fluctuate during the first period within the range of 1.1×P or higher after being increased to a value of 1.1×P or higher at the same time as the end of step S2 in which the nugget is formed.

In step S3 in which the current value between the electrodes is decreased to zero while the force on the steel sheets is maintained at 1.1×P or higher, a rate of decrease of the current value may be constant as shown in FIG. 3 or may fluctuate. This is because, in order to reduce the tensile stress during a period in which liquid zinc can be present, it is sufficient to decrease the current value over a predetermined time or longer.

For example, as shown in the stepwise graph of FIG. 4, a time for which the current value is constant may be provided while the current value is decreased. Specifically, when the current value between the electrodes is decreased to zero, the current value between the electrodes may be determined to be held at a constant value for a time between 265×tm or longer and 420 msec or longer in the unit of msec in the range from I×0.9 to I×0.3. In other words, the lower limit of the length of the second period may be the longer of 265×tm (msec), which is the lower limit corresponding to the sheet thickness, and 420 msec, which is the above-described lower limit. The current in the first period may be divided into two or three or more, for example, a first half of I×0.8 and a second half of I×0.6. However, under welding conditions including, for example, the main energizing in which the nugget 13 is formed and post energizing in which the nugget 13 is once cooled and then reheated, it is not acceptable to rapidly cool the weld after the main energizing and slowly cool the weld after the post energizing as described above. This is because LME cracking occurs during rapid cooling after the main energizing. That is, it is necessary to perform slow cooling under the above-described conditions when the current value is first set to I×0.9 or less after the nugget 13 is formed.

(Step S4)

The resistance spot welding method according to the present embodiment may further include, subsequent to step S3 in which the current value between the electrodes is decreased to zero while the force on the steel sheets is maintained at 1.1×P or higher, step S4 (so-called hold time) of holding the force by the electrodes A at 0.8×P or higher in the state where the current value between the electrodes A is set to zero. Accordingly, LME cracking in the corona bond 14 and an outside thereof can be suppressed, so that LME cracking can be more reliably prevented.

In a case where the disturbance becomes larger than expected in an actual production, there is a possibility that the temperature of the corona bond does not fall below 420° C. even if a length of the first period after the formation of the nugget is 420 msec or more. In such a case, in a case where the electrodes are released immediately after the current value becomes zero, there is a possibility that LME cracking occurs in the corona bond 14 and the outside of the corona bond 14. It is considered that by holding the force at 0.8×P or higher as described above without completely releasing the electrodes after the elapse of the first period, the introduction of the tensile stress due to the release of the force in a state in which liquid zinc remains can be more reliably avoided.

In step S4, a length of a period during which the force is held at 0.8×P or higher after the current value between the electrodes A is set to zero is preferably set to 0.04 sec (40 msec) or longer. From the viewpoint of suppressing LME cracking, it is considered that a longer hold time is preferable. Therefore, a time for which the force is held at 0.8×P or longer in step S4 may be set to 0.04 sec (40 msec) or longer, 0.06 sec (60 msec) or longer, or 0.08 sec (80 msec) or longer. However, when the hold time is too long, the effect of suppressing LME cracking is saturated, and a welding efficiency is lowered. Furthermore, when the time for which the force is maintained at 0.8×P or higher is longer than 400 msec, there is a possibility that auto-tempering (self-tempering) of the nugget that has been tempered does not progress in a process of decreasing the current after the electrodes are released, and a joint strength and hydrogen embrittlement resistance decrease. Therefore, in step S4, the time for which the force is held at 0.8×P or higher may be set to 0.4 sec (400 msec) or less, 0.3 sec (300 msec) or less, or 0.2 sec (200 msec) or less.

In step S4, the force may be maintained at 0.9×P or higher, 1.0×P or higher, 1.1×P or higher, or 1.2×P or higher. In addition, in step S4, the force may be set to a constant value as illustrated in FIG. 3. On the other hand, it is also acceptable that the force fluctuates during the holding period within a range of 0.8×P or higher.

Next, a resistance spot welded joint according to another aspect of the present invention will be described. A resistance spot welded joint 1 according to another aspect of the present invention includes: a plurality of overlapping steel sheets 11; and a weld having a nugget 13 by which the steel sheets 11 are joined, and having a corona bond 14 and a heat-affected zone 16 formed around the nugget 13, in which one or more of the plurality of steel sheets 11 are high strength steel sheets 11′ having a tensile strength of 780 MPa or more, one or more of the plurality of steel sheets 11 are plated steel sheets 11 having a zinc-based plating 12, the high strength steel sheet 11′ and the zinc-based plating 12 are adjacent to each other on a contact surface 15, a diameter of the heat-affected zone 16 is 1.5 times or more a diameter of the nugget 13, in the heat-affected zone 16, carbides having a circle equivalent diameter of 0.1 μm or more are distributed at a number density of 40/100 μm² or more, and in the corona bond 14, an amount of an η phase of the zinc-based plating 12 is 20 area % or less.

The resistance spot welded joint 1 according to the present embodiment includes the plurality of overlapping steel sheets 11, and one or more thereof are the high strength steel sheet 11′ having a tensile strength of 780 MPa or more. A composition, a metallographic structure, mechanical properties other than a tensile strength, and a shape of the steel sheet 11 are not particularly limited and can be appropriately selected depending on an application of the resistance spot welded joint.

In the resistance spot welded joint 1 according to the present embodiment, one or more steel sheets 11 include the zinc-based plating 12 on surfaces thereof. A type of the zinc-based plating 12 is not particularly limited, and forms such as hot-dip galvanizing, hot-dip galvannealing, and electrogalvanizing can be appropriately selected. An adhesion amount of the zinc-based plating 12 is also not particularly limited.

In the resistance spot welded joint 1 according to the present embodiment, the high strength steel sheet 11′ and the zinc-based plating 12 are adjacent to each other on one or more contact surfaces 15. Here, a state in which the high strength steel sheet 11′ and the zinc-based plating 12 are adjacent to each other means both
(a) a state in which the high strength steel sheet 11′ includes the zinc-based plating 12 on a surface thereof, and
(b) a state in which a steel sheet having a tensile strength of less than 780 MPa overlapping with the high strength steel sheet 11′ includes the zinc-based plating 12 and the zinc-based plating 12 is in contact with the high strength steel sheet 11′.

The resistance spot welded joint 1 according to the present embodiment includes a weld 17, which includes the nugget 13 by which the steel sheets 11 are joined, and the corona bond 14 and the heat-affected zone (HAZ) 16 formed around the nugget 13.

In the weld 17, a diameter of the heat-affected zone 16 is set to be 1.5 times or more a diameter of the nugget 13. Here, the diameters of the heat-affected zone 16 and the nugget 13 are values that are observed on a cut surface that is perpendicular to a sheet surface of the steel sheet 11 and passes through a center of the nugget 13. Furthermore, carbides having a circle equivalent diameter of 0.1 μm or more are distributed in the heat-affected zone 16 at a number density of 40/100 μm² or more. In addition, in the corona bond 14 of the resistance spot welded joint 1 according to the present embodiment, the amount of the η phase of the zinc-based plating is 20 area % or less. The η phase of the zinc-based plating 12 means a phase containing Zn as a primary component and other elements such as Fe in a solid solution state.

As described above, in a method for manufacturing the resistance spot welded joint 1 according to the present embodiment, a period during which a current value is decreased from I×0.9 to I×0.3 (that is, a second period) after energizing to form the nugget is longer than that in normal resistance spot welding. When resistance spot welding is performed under such conditions, a heat input increases compared to that in the related art, and the diameter of the heat-affected zone 16 (a region where a temperature reaches an Ac1 point or higher and a melting point or lower during welding) increases. In addition, since a cooling rate after releasing electrodes slows down, auto-tempering (self-tempering) of martensite formed in the heat-affected zone 16 during cooling progresses. As a result, carbides having a circle equivalent diameter of 0.1 μm or more are distributed in the heat-affected zone 16, and the density thereof becomes 40/100 μm² or more. In addition, when resistance spot welding is performed under such conditions, a heat input increases compared to that in the related art, and alloying of the zinc-based plating and the steel sheet progresses. As a result, in the corona bond 14, the amount of the η phase primarily containing zinc is 20 area % or less. In other words, it is presumed that the resistance spot welded joint in which the size of the heat-affected zone 16, the number density of carbides having a circle equivalent diameter of 0.1 μm or more included in the heat-affected zone 16, and the amount of the η phase of the zinc-based plating in the corona bond 14 are within the above ranges was obtained by the above-described method for manufacturing a resistance spot welded joint according to the present embodiment. A distribution density of the carbides is preferably 45/100 μm² or more, and more preferably 50/100 μm² or more.

A method of measuring the diameter of the heat-affected zone 16 and the diameter of the nugget 13 is as follows. First, the resistance spot welded joint is cut at a plane that passes through the center of the nugget 13 and is perpendicular to the sheet surface. Next, the cross section is polished, and the polished surface is corroded with an aqueous picric acid solution. Accordingly, outer edges of the nugget 13 and the heat-affected zone 16 can be visually recognized. The diameter of the heat-affected zone 16 and the diameter of the nugget 13 can be measured by appropriately magnifying and observing the corroded surface in a range of 10 to 50 times using an optical microscope.

A method of measuring the number density of carbides having a circle equivalent diameter of 0.1 μm or more in the heat-affected zone 16 is as follows. Similar to the procedure for measuring the diameter of the nugget 13 or the like, the resistance spot welded joint is cut, and the cross section thereof is polished and corroded. 10 measurement regions having a size of 5 μm×5 μm in the heat-affected zone 16 on the corroded surface are selected, and a photograph is taken at a magnification of 20,000-fold using a scanning electron microscope (SEM). The carbides can be easily visually recognized in this SEM photograph. Therefore, an area of each of the carbides included in the above-described measurement regions is measured using an image processor. Then, assuming that the shape of the carbide is a circle, a diameter of each of the carbides is calculated from the area of the carbide. The number of carbides having a diameter of 0.1 μm or more is counted, and this number is divided by a total area of the measurement regions, thereby obtaining the number density of the carbides. A method of measuring an area ratio of the η phase of the zinc-based plating 12 in the corona bond 14 is as follows. A distribution image of Zn and Fe of the corona bond in the cross section of the weld is photographed by SEM-EDS. The η phase in the image is defined as a region where a Zn concentration is 95% or more and an Fe concentration is 5% or less. Portions satisfying this definition and remaining portions are binarized by image analysis software, and the area ratio of the η phase in the plating layer of the corona bond is calculated. The area ratio of the η phase may be measured over the entire area of the corona bond, or may be measured by selecting three or more representative points such as both ends and the center of the corona bond.

The resistance spot welded joint 1 according to the present embodiment may satisfy any one or more of requirements listed below.

1: A raised portion of a shoulder portion 18 of the weld 17 protrudes outward by 0.1 mm or more from a surface of the steel sheet 11 on which the raised portion is formed.

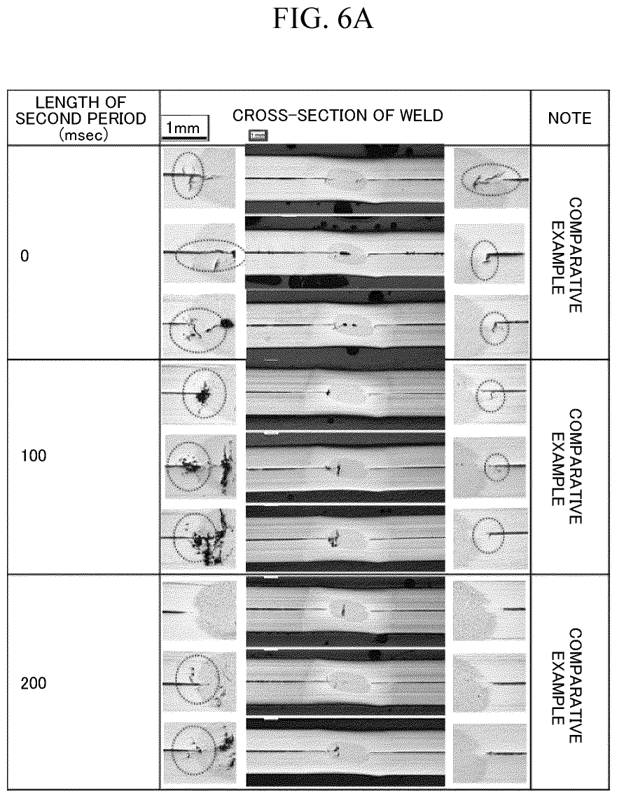

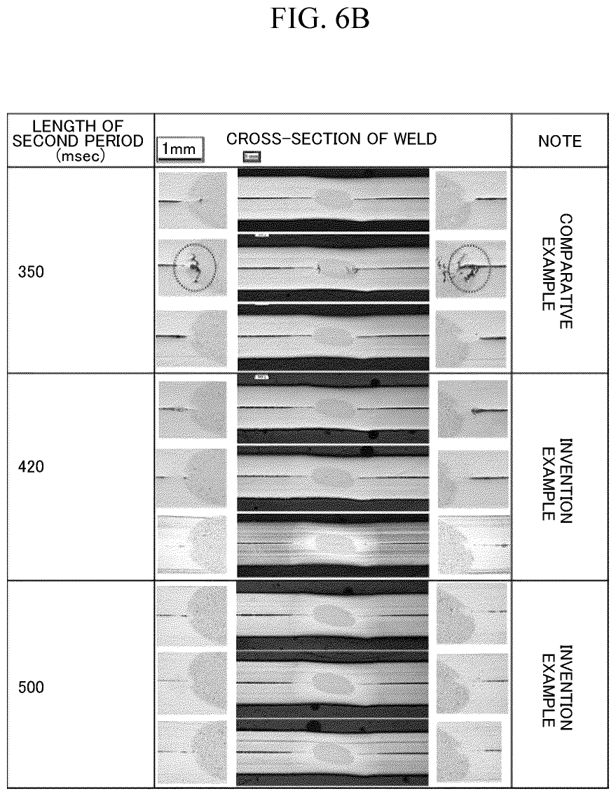

When there is a disturbance during resistance spot welding, the shoulder portion 18 of the steel sheet 11 is slightly raised at this outer edge. The shoulder portion 18 of the weld 17 is an outer edge of an indentation portion (indentation) on a surface obtained by cutting the weld 17 along a thickness direction of the steel sheet (see FIG. 2B). In a case where there is no disturbance during resistance spot welding, the shoulder portion 18 is not raised as much as shown in FIG. 2B. However, when there is a disturbance during resistance spot welding, a remarkable raised portion due to the force by the electrodes A is formed on the shoulder portion 18 (for example, see a cross-sectional photograph of FIG. 6A).

There are four shoulder portions 18 on the cut surface. A size of the raised portion in the shoulder portion 18 is evaluated with reference to the surface of the steel sheet 11 on which the raised portion is formed. A specific method of measuring the size of the raised portion is as follows. A cut surface that is perpendicular to the sheet surface of the steel sheet, passes through a center of the nugget, and passes through a portion where the raised portion of the shoulder portion of the weld is the largest is produced. The measurement is performed on this cut surface. An imaginary line along the surface of the steel sheet on which the raised portion is formed on an outside of the weld 17 is entered in a photograph of the cut surface. Then, a distance between an apex of the raised portion and the imaginary line is measured. In a case where this distance is 0.1 mm or more, it is determined that the raised portion of the shoulder portion 18 of the weld 17 protrudes outward by 0.1 mm or more from a surface of a first steel material 11 in which the raised portion is formed. As a matter of course, a steel sheet surface different from the surface of the steel sheet on which the raised portion to be evaluated is formed should not be used as a baseline when evaluating the size of the raised portion.

2: An angle formed by a major axis direction of the nugget 13 and the surface of the steel sheet 11 around the weld 17 is 2° or more.

The major axis direction of the nugget 13 means, in a case where the outer edge of the nugget 13 is regarded as an ellipse, a direction parallel to a major axis of the ellipse. An inclination of the major axis is an inclination of the nugget 13 caused by the disturbance. The inclination of the major axis is measured with reference to the surface of the steel sheet around the weld (specifically, a region within 20 mm from the outer edge of the heat-affected zone 16 of the weld 17). That is, the angle formed by the surface of the steel sheet around the weld and the major axis direction of the nugget 13 is used as a value for evaluating the inclination of the nugget 13. In a case where the shape of the nugget 13 is not substantially elliptical, a straight line is drawn on the cross section of the weld at a point where the nugget diameter is the largest, and an angle between the straight line and the surface of the steel sheet around the weld is regarded as the inclination of the nugget 13. In a case where the surface of the steel sheet at a portion distant from the weld 17 is used as a reference, there is a concern that a strain of the steel sheet affects the evaluation result of the inclination of the nugget 13. The angle formed by the major axis direction of the nugget 13 and the surface of the steel sheet 11 around the weld 17 is a value measured on the cut surface that is perpendicular to the sheet surface of the steel sheet and passes through the center of the nugget.

3: A sheet separation in the contact surface 15 at which the high strength steel sheet 11′ and the zinc-based plating 12 are adjacent to each other is 0.3 mm or more.

Here, the sheet separation is a size of a gap between the steel sheets 11 generated at the contact surface 15, and is defined as a value measured on the cut surface that is perpendicular to the sheet surface of the steel sheet 11 and passes through the center of the nugget 13 at a portion 2 mm away from an end portion of the corona bond 14.

As described above, the disturbance during the resistance spot welding increases the tensile stress in the weld and promotes LME cracking. In addition, the disturbance causes the above-described raising of the surface of the steel sheet 11, the inclination of the nugget 13, and/or the sheet separation. Therefore, it can be said that the resistance spot welded joint 1 that satisfies one or more of the above three requirements is formed under conditions in which there is a disturbance and LME cracking is likely to occur. It is presumed that in manufacturing of a normal resistance spot welded joint, when such a disturbance is present, LME cracking occurs, and a joint thus obtained does not form a body as a mechanical component. However, since the resistance spot welded joint 1 according to the present embodiment is formed under conditions in which the number density of carbides having a predetermined circle equivalent diameter included in the heat-affected zone 16 is within the above-described range, LME cracking does not occur. Therefore, it can be said that the resistance spot welded joint according to the present embodiment that satisfies one or more of the above requirements has a further advantage over the normal resistance spot welded joint.

### EXAMPLES

Effects of one aspect of the present invention will be described more specifically with reference to examples. Conditions in the examples are merely one example of conditions adopted to confirm the feasibility and effects of the present invention. The present invention is not limited to this one example of conditions. The present invention can adopt various conditions as long as the object of the present invention is achieved without departing from the gist of the present invention.

### Example 1

Various resistance spot welded joints were manufactured by resistance spot welding including applying force on two overlapping steel sheets using a pair of electrodes facing each other, forming a nugget and a corona bond by energizing the electrodes while applying the force on the steel sheets, and decreasing a current value between the electrodes to zero while holding the force on the steel sheets.

The steel sheet was disposed substantially horizontally, and the pair of electrodes was disposed with the steel sheets clamped therebetween. The electrode disposed on the steel sheet was set as a movable electrode, the electrode disposed under the steel sheet was set as a fixed electrode, and the upper electrode was moved toward the lower electrode to apply force on the steel sheets. At the start of energizing, the current value was momentarily increased to a predetermined value, and then the current value was maintained constant until the nugget was completed.

Other welding conditions are shown below. A hitting angle is an angle formed by an axial direction of the movable electrode and a direction perpendicular to a surface of the steel sheet. A clearance refers to the disturbance described in (b) of paragraph 0021 of Patent Document 4 and FIG. 5. The hitting angle and the clearance are disturbance elements of resistance spot welding and are factors that cause LME cracking. By setting the hitting angle and the clearance as described below, LME cracking was made to occur more easily. A force was held at P for a period described below after the formation of the nugget.
Welder: Servo pressure stationary welder, single-phase AC (frequency 50 kHz)
Electrode: Dome radius (DR) Cr—Cu
Shape of electrode tip: φ6 mm, R40 mm
Force P at the time when the formation of the nugget is completed: 3.9 kN
Current value I at a time when the formation of the nugget is completed: 6 kA (condition for forming a nugget of 4√t or less) where t is the smallest sheet thickness (mm) among the overlapping steel sheets.
Energizing time when forming a nugget: 15 cycles (0.3 sec)
Hold time of force from the time when the current becomes zero: 4 cycles or 99 cycles (0.08 sec or 1.98 sec)
Hitting angle: 3°
Clearance: 0.3 mm
Type of steel sheet: Both of the two steel sheets were hot-dip galvannealed (GA) 980 MPa-grade steel (a 980 MPa-grade high strength steel sheet and a hot-dip galvanneal were in contact with each other on a contact surface).
Thickness of steel sheet: 1.6 mm for both sheets (tm=1.6)
A length of a second period after forming the nugget was changed in a range of 0 to 500 msec.
A force P′ after forming the nugget was changed in a range of 1.0 to 1.4 times P.

Resistance spot welding was performed 10 times under each condition. A resistance spot welded joint thus obtained was cut along a plane passing through the center of the nugget and perpendicular to the surface of the steel sheet, and a cross section thereof was appropriately prepared and observed with an optical microscope. The observation results are shown in FIGS. 6A and 6B.

In the resistance spot welding of comparative examples in which, when the current value between the electrodes was decreased to zero, the length of the period during which the current value between the electrodes was decreased from I×0.9 to I×0.3 (that is, the second period) was set to be less than 420 msec, the occurrence of LME cracking was frequently observed. As the length of this period was shorter, the frequency of occurrence of LME cracking tended to increase. On the other hand, according to the resistance spot welding of invention examples in which the length of the second period was set to 420 msec or more when the current value between the electrodes was decreased to zero, LME cracking could be suppressed.

In the present invention examples, the resistance spot welded joints obtained under the condition in which the length of the second period was 420 msec were observed in detail. Specifically, a ratio between a diameter of a heat-affected zone and a diameter of the nugget, a number density of carbides having a circle equivalent diameter of 0.1 μm or more in the heat-affected zone, a size of a raised portion of a shoulder portion of a weld, an angle between a major axis direction of the nugget and the contact surface adjacent to the weld, and a sheet separation were evaluated.

The sheet separation, the angle between the major axis direction of the nugget and a surface of one side of the steel sheet adjacent to the weld, and a height of the raised portion of the shoulder portion of the weld were measured by cutting the resistance spot welded joint on a plane passing through a center of the nugget of the spot weld, passing through the largest portion of the raised portion of the shoulder portion of the weld, and perpendicular to the sheet surface, polishing the cross section, corroding the polished surface using an aqueous picric acid solution, and appropriately magnifying and observing the corroded surface using an optical microscope in a range of 10- to 50-fold. In addition, in a case where there is no raised portion in the shoulder portion of the weld by visual inspection of the external appearance, the above-described measurement may be measured by cutting the nugget on any plane passing through the center of the nugget of the spot weld and perpendicular to the sheet surface.

The size of the heat-affected zone and the nugget diameter (diameter) were measured by observing the corroded surface prepared in the above procedure with an optical microscope.

The density of carbides having a circle equivalent diameter of 0.1 μm or more was obtained from an image taken at a magnification of 20,000-fold using a scanning electron microscope (SEM), the image including 10 selected regions having a size of 5 μm×5 μm in the heat-affected zone on the corroded surface prepared by the above procedure. Here, the circle equivalent diameter of each carbide included in a measurement visual field was obtained by obtaining an area of each carbide using an image processor and calculating the circle equivalent diameter from the value. Then, carbides having a circle equivalent diameter of 0.1 μm or more were specified, and the total number of the carbides was divided by the total area of the photographed region to calculate the distribution density of the carbides.

As a result, the sheet separation was 0.14 mm. The angle between the major axis direction of the nugget and a normal to a steel sheet base metal adjacent to the weld was 3°. The height of the raised portion of the shoulder portion of the weld was 0.16 mm. The heat-affected zone diameter/nugget diameter was 2.3, and the density of carbide having a particle size of 0.1 μm or more was 55/100 μm². Since the raising of the shoulder portion of the weld, the inclination of the nugget, and the sheet separation had occurred in the resistance spot welded joint of the present invention, it can be said that the resistance spot welded joint of the present invention was formed under a disturbance condition in which LME cracking is likely to occur. However, the resistance spot welded joint of the present invention is a joint in which there is no LME crack in the corona bond.

### Example 2

For the hot-dip galvannealed steel sheets shown in Table 1, various resistance spot welded joints were manufactured under the conditions shown in Table 2. In any of the welded joints, types of the two steel sheets were the same. In addition, resistance spot welding was performed 10 times under each condition. An energizing profile was a stepwise shape as illustrated in FIG. 4. That is, a current value in energizing in a second stage was set to be constant. Then, in the manufactured resistance spot welded joints, the number of nuggets in which LME cracking occurred was confirmed and is shown in Table 2. Furthermore, an η area ratio of a zinc-based plating in a corona bond was also measured and is shown in Table 1.

The “current I” in Table 2 corresponds to the “current value I between the electrodes at the time when the formation of the nugget is completed”. The “force in second stage” in Table 2 corresponds to the “force in the first period”. The “current in second stage” in Table 2 corresponds to the “average value Iave of the current value between electrodes in the first period”. The “energizing time in second stage” in Table 2 corresponds to the “length of the second period”. Welding conditions not shown in Table 2 were based on Example 1 described above. The length of step S4, that is, the hold time was set to 10 cycles (200 msec). In addition, the “number density of carbides in heat-affected zone” in Table 2 refers to the number density of carbides having a circle equivalent diameter of 0.1 μm or more.

TABLE 1

| | | | | η area ratio | Ratio of | Number | | |
|---|---|---|---|---|---|---|---|---|
| | | | | in plating | diameter of | density of | | |
| | | | | alloy | heat- | carbides in | | Tensile |
| | | | | layer | affected | heat- | Sheet | strength |
| | Kind | Amount | Amount | in corona | zone to | affected | thickness | of steel |
| | of | of C | of Si | bond | diameter of | zone | H | sheet |
| No. | steel | (mass %) | (mass %) | (%) | nugget | (/100 μm²) | (mm) | (MPa) |
| 1 | Steel | 0.22 | 1.2 | 32 | 1.25 | 23 | 1.6 | 1012 |
| | sheet | | | | | | | |
| | 1 | | | | | | | |
| 2 | Steel | 0.22 | 1.2 | 33 | 1.23 | 26 | 1.6 | 1012 |
| | sheet | | | | | | | |
| | 1 | | | | | | | |
| 3 | Steel | 0.22 | 1.2 | 22 | 1.41 | 33 | 1.6 | 1012 |
| | sheet | | | | | | | |
| | 1 | | | | | | | |
| 4 | Steel | 0.22 | 1.2 | 15 | 1.62 | 44 | 1.6 | 1012 |
| | sheet | | | | | | | |
| | 1 | | | | | | | |
| 5 | Steel | 0.22 | 1.2 | 32 | 1.25 | 23 | 1.6 | 1012 |
| | sheet | | | | | | | |
| | 1 | | | | | | | |
| 6 | Steel | 0.10 | 0.6 | 26 | 1.35 | 26 | 1.6 | 1031 |
| | sheet | | | | | | | |
| | 2 | | | | | | | |
| 7 | Steel | 0.10 | 0.6 | 26 | 1.40 | 28 | 1.6 | 1031 |
| | sheet | | | | | | | |
| | 2 | | | | | | | |
| 8 | Steel | 0.10 | 0.6 | 18 | 1.53 | 43 | 1.6 | 1031 |
| | sheet | | | | | | | |
| | 2 | | | | | | | |

TABLE 2

| | Force | | Force | Current | | | Energizing | | |
|---|---|---|---|---|---|---|---|---|---|
| | in | | in | in | | | time in | | |
| | first | Current | second | second | 0.9 × | 0.3 × | second | Number | |
| | stage | I | stage | stage | I | I | stage | of | |
| No. | (kN) | (kA) | (kN) | (kA) | (kA) | (kA) | (ms) | cracks | Note |
| 1 | 3.9 | 6 | 3.9 | 4.5 | 5.4 | 1.8 | 50 | 7 | Comparative |
| | | | | | | | | | Example |
| 2 | 3.9 | 6 | 4.5 | 4.5 | 5.4 | 1.8 | 50 | 6 | Comparative |
| | | | | | | | | | Example |
| 3 | 3.9 | 6 | 4.5 | 4.5 | 5.4 | 1.8 | 350 | 3 | Comparative |
| | | | | | | | | | Example |
| 4 | 3.9 | 6 | 4.5 | 4.5 | 5.4 | 1.8 | 450 | 0 | Invention |
| | | | | | | | | | Example |
| 5 | 3.9 | 6 | 4.5 | 1.6 | 5.4 | 1.8 | 450 | 7 | Comparative |
| | | | | | | | | | Example |
| 6 | 4.4 | 6.4 | 4.4 | 4.5 | 5.8 | 1.9 | 50 | 7 | Comparative |
| | | | | | | | | | Example |
| 7 | 4.4 | 6.4 | 5.1 | 4.5 | 5.8 | 1.9 | 300 | 4 | Comparative |
| | | | | | | | | | Example |
| 8 | 4.4 | 6.4 | 5.1 | 4.5 | 5.8 | 1.9 | 450 | 0 | Invention |
| | | | | | | | | | Example |

*Among 10 tests, zero (no) crack is evaluated as good.

Condition 4 and condition 8 are welding conditions that satisfy the requirements
(1) the current value I between the electrodes at the time when the formation of the nugget is completed and the average value Iave of the current value between the electrodes in the first period satisfy a relationship of 0.30×I≤Iave≤0.90×I,
(2) the length of the second period is set to 420 msec or more, and
(3) the force in the first period is set to 1.1 times or more the force P at the time when the formation of the nugget is completed.

In the resistance spot welded joints obtained under condition 4 and condition 8, the number of cracks was 0. That is, in the method for manufacturing a resistance spot welded joint satisfying the above-described requirements (1) to (3), even though the zinc-based plating and the high strength steel sheet were adjacent to each other on the contact surface, a resistance spot welded joint in which no LME cracking occurred in a corona bond could be manufactured. In the resistance spot welded joints obtained under condition 4 or condition 8,
(A) the diameter of the heat-affected zone was 1.5 times or more the diameter of the nugget,
(B) carbides having a circle equivalent diameter of 0.1 μm or more were distributed in the heat-affected zone at a number density of 40/100 μm² or more, and
(C) the amount of the η phase of the zinc-based plating in the corona bond was 20 area % or less.

On the other hand, other welding conditions did not satisfy one or more of the above requirements (1) to (3).

Specifically, under condition 1, both the force in the second stage (that is, the force in the first period) and the energizing time in the second stage (that is, the length of the second period) were insufficient, and the above-described requirements (2) and (3) were not satisfied.

Under condition 2, the energizing time in the second stage (that is, the length of the second period) was insufficient, and the above-described requirement (2) was not satisfied.

Under condition 3, the energizing time in the second stage (that is, the length of the second period) was insufficient, and the above-described requirement (2) was not satisfied.

Under condition 5, the current in the second stage (that is, the average value lave of the current value between the electrodes in the first period) was insufficient, and the above-described requirement (1) was not satisfied.

Under condition 6, both the force in the second stage (that is, the force in the first period) and the energizing time in the second stage (that is, the length of the second period) were insufficient, and the above-described requirements (2) and (3) were not satisfied.

Under condition 7, the energizing time in the second stage (that is, the length of the second period) was insufficient, and the above-described requirement (2) was not satisfied.

In the resistance spot welded joints obtained under these conditions, LME cracking had occurred. In the resistance spot welded joint obtained under these conditions, any one or more of (A) the diameter of the heat-affected zone, (B) the number density of the carbides in the heat-affected zone, and (C) the amount of the η phase in the corona bond were outside of the ranges of the present invention.

### INDUSTRIAL APPLICABILITY

According to the present invention, it is possible to provide a resistance spot welded joint and a method for manufacturing a resistance spot welded joint in which LME cracking does not occur in a corona bond even though a zinc-based plating and a high strength steel sheet are adjacent to each other on a contact surface. Therefore, the present invention has high industrial applicability.

### BRIEF DESCRIPTION OF THE REFERENCE SYMBOLS

1 Resistance spot welded joint
11 Steel sheet
11′ High strength steel sheet
12 Zinc-based plating
13 Nugget
14 Corona Bond
15 Contact surface
16 heat-affected zone (HAZ)
17 Weld
18 Shoulder portion
A Electrode
C LME crack

1. A resistance spot welded joint comprising:
a plurality of overlapping steel sheets; and
a weld having a nugget by which the steel sheets are joined, and having a corona bond and a heat-affected zone formed around the nugget,
wherein one or more of the plurality of steel sheets are high strength steel sheets having a tensile strength of 780 MPa or more,
one or more of the plurality of steel sheets are plated steel sheets having a zinc-based plating,
the high strength steel sheet and the zinc-based plating are adjacent to each other on a contact surface,
a diameter of the heat-affected zone is 1.5 times or more a diameter of the nugget,
in the heat-affected zone, carbides having a circle equivalent diameter of 0.1 μm or more are distributed at a number density of 40/100 μm² or more, and
in the corona bond, an amount of an η phase of the zinc-based plating is 20 area % or less.

2. The resistance spot welded joint according to claim 1, wherein one or more of the following three requirements is satisfied:
1: a raised portion of a shoulder portion of the weld protrudes outward by 0.1 mm or more from a surface of the steel sheet on which the raised portion is formed;
2: an angle between a major axis direction of the nugget and the surface of the steel sheet around the weld is 2° or more; and
3: a sheet separation in the contact surface at which the high strength steel sheet and the zinc-based plating are adjacent to each other is 0.3 mm or more.

3. A method for manufacturing a resistance spot welded joint, the method comprising:
applying a force on a plurality of overlapping steel sheets using a pair of electrodes facing each other;
forming a nugget and a corona bond by energizing the electrodes while applying the force on the steel sheets; and
decreasing a current value between the electrodes to zero while holding a force on the steel sheets,
wherein one or more of the plurality of steel sheets include a zinc-based plating, and
one or more of the plurality of steel sheets are high strength steel sheets having a tensile strength of 780 MPa or more,
the high strength steel sheet and the zinc-based plating are brought adjacent to each other on a contact surface,
a current value I between the electrodes at a time when the formation of the nugget is completed, and an average value Iave of the current value between the electrodes in a first period, which is a period from the time when the formation of the nugget is completed to a time when the current value is set to zero, satisfy a relationship of 0.30×I≤Iave≤0.90×I,
a length of a second period, which is a period from a time when the current value is set to 0.90×I to a time when the current value is set to 0.30×I, is set to 420 msec or more, and
a force in the first period is set to be 1.1 times or more a force P at the time when the formation of the nugget is completed.

4. The method for manufacturing a resistance spot welded joint according to claim 3,
wherein, in a case where ½ of a total sheet thickness of the steel sheet in a unit of mm is defined as tm, while the current value between the electrodes is decreased to zero, the current value between the electrodes is held at a constant value in a range of I×0.9 to I×0.3 for a time between 265×tm or longer and 420 msec or longer in a unit of msec.

5. The method for manufacturing a resistance spot welded joint according to claim 3, further comprising:
after the decreasing of the current value between the electrodes to zero, holding the force at 0.8×P or higher for a time between 0.04 sec or longer and 0.4 sec or shorter in a state where the current value between the electrodes is set to zero.

6. The method for manufacturing a resistance spot welded joint according to claim 3, wherein Iave and I satisfy a relationship of 0.45×I≤Iave≤0.85×I.

7. The method for manufacturing a resistance spot welded joint according to claim 3,
wherein, in a case where ½ of a total sheet thickness of the steel sheet in a unit of mm is defined as tm, the length of the second period is set to 265×tm or more and 420 msec or more in a unit of msec.
